(19) United States
(12) Patent Application Publication
(10) Pub. No.: US 2010/0039895 A1
(43) Pub. Date: Feb. 18, 2010

(54) METHODS AND SYSTEMS FOR DETECTING CHANGES IN A FLUID RESERVOIR

(75) Inventor: Ernst D. Rode, Isera (TN) (IT)

Correspondence Address: Joseph A. Mohr;Kolisch Hartwell, P.C., 200 Pacific Building, 520 S.W. Yamhill Street, Portland, OR, 97204, US

(73) Assignee: Geoiab S.a.s., Trento (IT)

(21) Appl. No.: 12/395,058

(22) Filed: Feb. 27, 2009

(30) Foreign Application Priority Data
Aug. 12, 2008 (EP) 08014357.1

(51) Int. Cl. G01V 1/34

(52) U.S. Cl. 367/73

(57) ABSTRACT

Methods and systems for detecting changes of a fluid in a subterranean reservoir, wherein at several points in time, data are collected with the aid of a passive method in which low-frequency acoustic signals are passively measured by means of acoustic sensors. Changes in the fluid can be monitored in a simple and cost efficient way when these data are overlaid with static 3D data, which were collected with the aid of a reflection-seismic method so that a time-related representation of the change of the fluid is possible.

### RELATED APPLICATIONS

This application claims priority under 35 U.S.C. §119(a)-(d) to European Patent Application No. 08014357.1 entitled “Method for detecting of changes in a hydrocarbon deposit,” which was filed on Aug. 12, 2008, with the European Patent Office. The disclosure of European Patent Application No. 08014357.1 is incorporated herein by reference for all purposes. The above application was filed under the Paris Convention for the Protection of Industrial Property, of which Europe and the United States are contracting parties.

### BACKGROUND

This disclosure relates to methods and systems for detecting changes of a fluid in a subterranean reservoir. Hydrocarbon deposits such as, for example, oil and gas fields, can be exploited with conventional means to a certain extent. For example, with conventional means only approximately 28% to 34% of the raw hydrocarbon can be recovered. This means that about 66% to 72% of the raw material remains in the reservoir. In some regions, the recovery factor is considerably lower. With regard to the limited reserves of the resources, the oil-producing industry seeks solutions for increasing the recovery factor.

To increase the supply rate of a reservoir, it is known to inject a fluid, for example water or a gas, into the reservoir to increase the internal pressure of the reservoir. It is very important to know where the periphery of the hydrocarbon deposit is located. It is also important to monitor and control the effect of the water injection because an injection of water into the wrong areas of the reservoir can result in a destruction of portions of the reservoir. In the worst case, the permeability of the rock reduces so much that the deposit can not be exploited further.

In recent years, a method has been developed in which, in certain intervals, reflection-seismic studies are carried out to monitor the changes of a fluid in a reservoir. This method is also denoted as “4D seismic”. By comparing data recorded at different points in times, it is possible to make conclusions about the changes of the fluidic systems in the reservoir and the changes of the lithosphere.

The 4D-seismic method, on the one hand, has the drawback of being very sensitive to changing measuring conditions. Only with almost identical measuring conditions can meaningful data be obtained. Furthermore, just one single seismic study is very expensive, for example, typically costing several million Euro.

Therefore, there exists a need for methods and systems to simply and inexpensively monitor the time behavior of a fluid, in particular oil, gas, or water, in a reservoir.

### SUMMARY

This disclosure describes methods and systems for detecting changes of a fluid in a subterranean reservoir, wherein at several points in time, data are collected with the aid of a passive method in which low-frequency acoustic signals are passively measured by means of acoustic sensors. Changes in the fluid can be monitored in a simple and cost efficient way when these data are overlaid with static 3D data, which were collected with the aid of a reflection-seismic method so that a time-related representation of the change of the fluid is possible.

### BRIEF DESCRIPTION OF THE DRAWINGS

FIG. 1 shows a flow diagram comprising the relevant method steps for creating a dynamic structure model.

FIG. 2 shows different components of a system for creating a dynamic structure model.

FIG. 3 shows a spectrum of a gas well operating with an open well.

FIG. 4 shows the spectrum of the same well six months later with a closed well.

FIG. 5 shows symbolically the pressure distribution near an open well and near a closed well.

### DETAILED DESCRIPTION

The disclosed methods and systems to detect changes in hydrocarbon deposits will become better understood through review of the following detailed description in conjunction with the drawings and the claims. The detailed description, drawings, and claims provide merely examples of the various inventions described herein. Those skilled in the art will understand that the disclosed examples may be varied, modified, and altered without departing from the scope of the inventions as defined in the claims, and all equivalents to which they are entitled. Many variations are contemplated for different applications and design considerations; however, for the sake of brevity, each and every contemplated variation is not individually described in the following detailed description.

The following detailed description describes methods and systems to detect changes in a fluid reservoir, such as in a hydrocarbon deposit. Before making reference to the figures, an overview of the methods and systems is provided.

In some examples, the methods and systems involve collecting data about a hydrocarbon deposit by means of a passive method and superimposing those data with static 3D data which were gathered using a reflection-seismic method. From the 3D data, a structure model can be generated which represents the lithologic structure of the earth's crust. By superimposing the static structure model with the passively recorded data, a change in the hydrocarbon deposit can be monitored. The combination of passively recorded (dynamic) data and reflection-seismic (static) data allows the behavior of an underground hydrocarbon deposit to be monitored very accurately and inexpensively.

Passive methods, as the term is used in this disclosure, operate with acoustic sensors which receive low-frequency acoustic signals at the earth's surface or close to the earth's surface. With these methods it is possible, for example, to determine the volume or the depth of a hydrocarbon deposit. Passive exploration methods have been described in the literature and in different patents, such as, for example, in DE 199 15 036, DE 10 2004 028 034, or EP 0 904 779, which are expressly incorporated herein by reference for all permissible purposes. These methods are also denoted as “Infrasonic Passive Differential Spectroscopy”, hereinafter referred to as IPDS.

The passive measuring method is carried out at two or more different points in time, but is preferably carried out continuously or at regular intervals. The passively recorded data can contain information about the geometrical extent of the fluid, the depth of the horizon, or the pressure in the reservoir at different places. Further characteristics of the fluid, such as, for example, the position of a boundary layer (for example, between oil and water) can be monitored as well.

In one embodiment of the invention, the passively recorded data are measured by means of fixed acoustic sensors. A fixed acoustic sensor is an acoustic sensor that is used for at least two subsequent measurements at the place it is installed. A fixed or permanently installed system can be advantageous because it can provide for successive measurements to be taken without repeated placement of sensors. Not having to repeatedly place or install sensors can provide for significantly cheaper and more efficient measurements. In addition, a permanently installed system allows online monitoring of fluid measurements and of fluid changes.

The data collected by the acoustic sensors may be transferred via a wired or wireless communication interface, such as radio broadcasts, to an evaluation unit, also referred to as a processing device. A static structure model, generated from the reflection-seismic measuring data, may already be present in the processing device. The static structure model may be combined or superimposed with the passively recorded data to create a dynamic structure model, by means of which time-related changes of the fluid can be illustrated. In addition, further data can be added to the dynamic structure model, such as e.g. pressure, temperature, supply rates, and water content, which are measured by means of other sensors.

The reflection-seismic 3D data are preferably recorded only once. Repeated reflection-seismic measurements are not required. The methods and systems according to the present disclosure may therefore be considerably more cost effective than known 4D seismic methods.

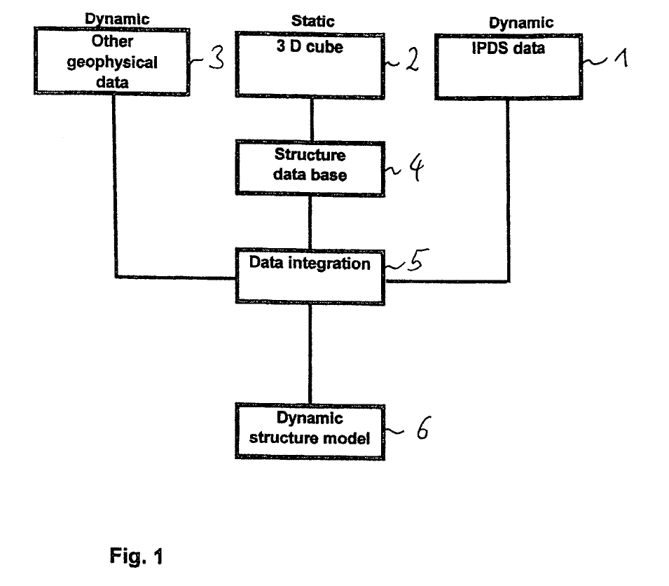

Turning now to the figures, FIG. 1 shows one example of a method of monitoring fluid changes in a subterranean reservoir, in particular an oil or gas reservoir.

According to block 1, a passive measuring method is carried out in which low-frequency acoustic signals are measured passively by means of acoustic sensors. From a spectral analysis of the received seismic waves in a frequency range, for example between 0.5 and 10 Hz, information about a hydrocarbon deposit can be determined. For example, the information may include the existence of a hydrocarbon deposit, the extent of the hydrocarbon deposit, and, if applicable, the depth of the hydrocarbon deposit. This and related information will hereinafter be referred to as IPDS data.

As shown at block 2, 3D data describing in three dimensions the lithologic structure of the earth's crust are collected in addition to the IPDS data 1. In some examples, the 3D data are already available. These 3D data 2 preferably originate from one or more reflection-seismic measurements.

The 3D data 2, the so-called 3D cube, are stored in a structure data base (block 4). The IPDS data 1 and the 3D data 2 are linked in step 5. Finally, in step 6, a dynamic structure model is generated which allows an illustration of the static lithologic 3D structure and the time-related change of the fluid in the reservoir.

After generating a dynamic structure model 6, changes in the fluid can be monitored. For example, changes in the fluid that occur after an injection of water or gas can be monitored. The changes are preferably illustrated or displayed on the monitor of a computer and can selectively be viewed forward or backward in time. When the passively collected data are continuously collected and stored, it is possible to view the changes at any point in time in the past (forensic spectroscopy). Moreover, it is possible at any time to re-determine the analysis parameters, which is a major advantage compared to the known 4D seismic methods.

Optionally, further geophysical data can be collected in step 3 and integrated into the dynamic structure model. Geophysical data may include pressure, temperature, supply rates, and water content, which are measured by means of other sensors

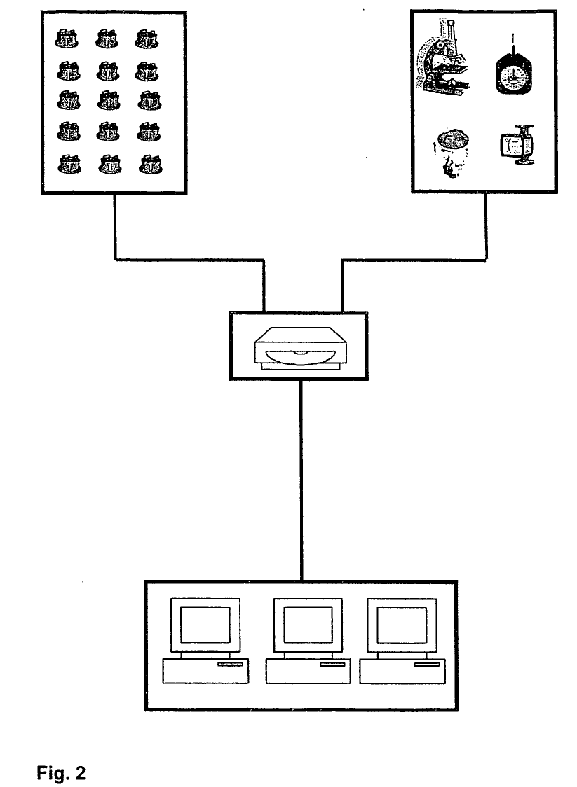

FIG. 2 shows a schematic block diagram of a system that enables fluid changes in a subterranean reservoir to be monitored. In FIG. 2, block 10 indicates a plurality of passive acoustic sensors which are permanently or semi-permanently installed at different places. The data collected by sensors 10 are transferred via a communication connection 13, such as via radio waves,, to an evaluation unit or processing device 12. If not already available, the reflection-seismic 3D data 3 are stored in the processing device 12. Block 11 indicates one or more measuring instruments, by means of which further geophysical data can be determined. These data can also be integrated in the processing device.

From the available data, the processing device 12 generates a dynamic structure model, in which dynamic changes in the fluid can be monitored. The data can selectively be viewed directly at the processing device 12, or they are sent via a data connection 14 to one or more computers 15, and can be retrieved there. By means of the permanent installation of the sensors 10, it is possible to monitor changes in the fluid online.

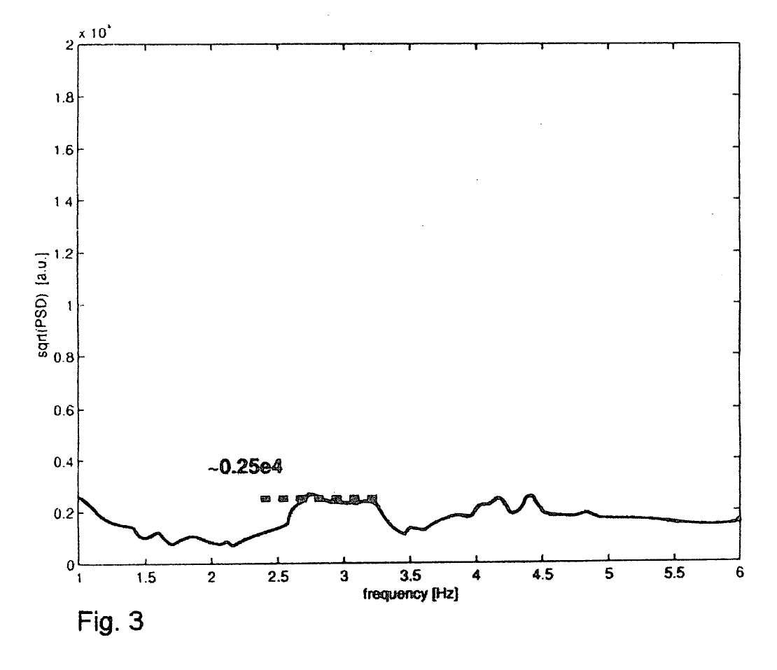

FIG. 3 shows the spectrum of a gas well while running or operating with an open well. As can be seen, the maximum at approximately 3 Hz is about 0.25e4 units.

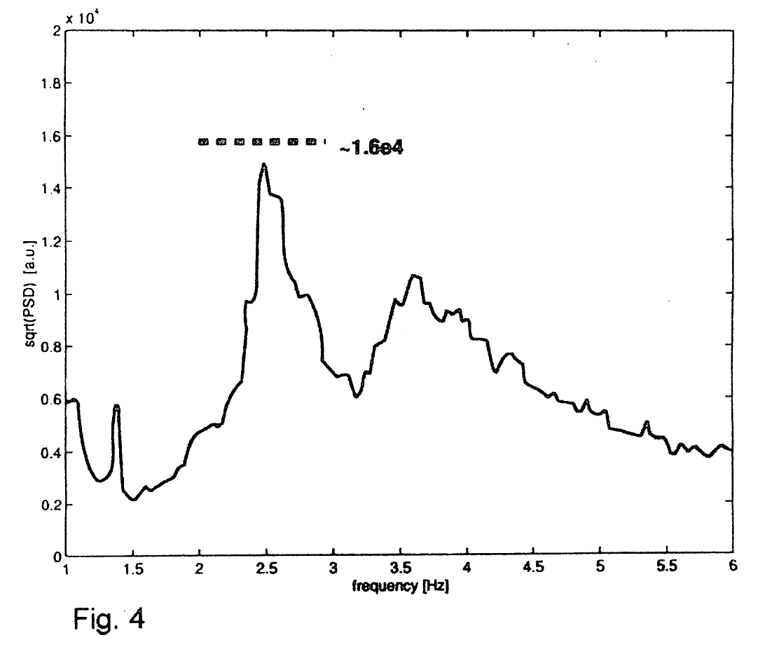

FIG. 4 shows the spectrum of the same well as shown in FIG. 3, but 6 months later and with a closed well. These data were passively collected by means of sensors 10. As can be seen, the spectrum of FIG. 4 shows considerably higher maxima than the spectrum of FIG. 3. This is because the internal reservoir pressure has increased within a period of 6 months after closure of the well, and the anomaly caused by the fluid is intensified in the seismic spectrum.

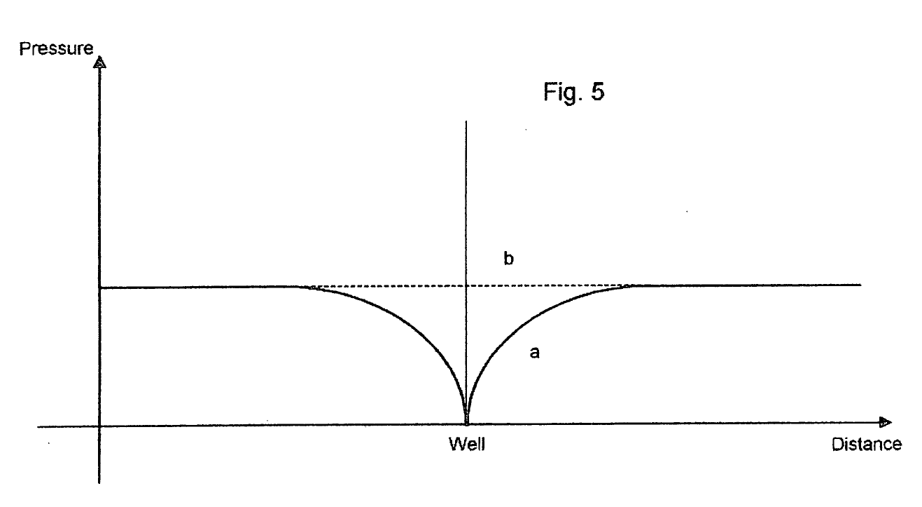

FIG. 5 shows finally the symbolic pressure distribution near an open well and near a closed well. Line “a” represents the pressure curve in the reservoir with an open well and line “b” represents the pressure level p₀ in the reservoir with a closed well.

The system shown in FIG. 2 and described herein allows a continuous analysis of the dynamic behavior of the fluids in the reservoir. With the aid of the information fed from the system, the recovery factor of the reservoir can be increased considerably.

In case of a permanent installation of the sensors 10, this system is also suitable for collecting acoustic data which are not related to the behavior of the fluids in the reservoir, but that can be used to determine changes in the environmental conditions relevant to the reservoir. Thus, for example, driving on or entering the measured region can be detected by means of the sensor signals 10. Hence it is possible to protect an exploration area against possible terrorist attacks or to detect the trespassing of unauthorized persons.

It is believed that the disclosure set forth above encompasses multiple distinct inventions with independent utility. While each of these inventions has been disclosed in a particular form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein, and equivalents of them. Where the disclosure or subsequently filed claims recite “a” or “a first” element or the equivalent thereof, it is within the scope of the present inventions that such disclosure or claims may be understood to include incorporation of one or more such elements, neither requiring nor excluding two or more such elements.

Applicant reserves the right to submit claims directed to certain combinations and subcombinations that are directed to one of the disclosed inventions and that are believed to be novel and non-obvious. Inventions embodied in other combinations and subcombinations of features, functions, elements and/or properties may be claimed through amendment of those claims or presentation of new claims in that or a related application. Such amended or new claims, and the equivalents thereof, whether the claims are directed to a different invention or directed to the same invention, whether different, broader, narrower or equal in scope to the original claims, are also regarded as included within the subject matter of the inventions of the present disclosure.

1.-10. (canceled)

11. A method for detecting fluid changes in a subterranean reservoir, comprising:
measuring low-frequency acoustic signals with acoustic sensors positioned near a subterranean reservoir at two or more points in time;
storing the low-frequency acoustic signals in a computer readable medium as a set of passive data; and
superimposing at least a portion of the set of passive data with static 3D data, which represents the structure of the subterranean reservoir and Which Were collected from a reflection-seismic method, to create a model representing time-dependant changes of the fluid in the reservoir.

12. The method of claim 11, wherein measuring low-frequency acoustic signals includes measuring low-frequency acoustic signals from permanently installed acoustic sensors.

13. The method of claim 12, further comprising wirelessly transferring the low-frequency acoustic signals from the acoustic sensors to an evaluation unit.

14. The method of claim 13, wherein wirelessly transferring the low-frequency acoustic signals includes transferring the low-frequency acoustic signals via radio waves.

15. The method of claim 11, further comprising wirelessly transferring the low-frequency acoustic signals from the acoustic sensors to an evaluation unit.

16. The method of claim 15, wherein wirelessly transferring the low-frequency acoustic signals includes transferring the low-frequency acoustic signals via radio waves.

17. The method of claim 11, wherein the 3D structure data are collected from a single run of a reflection-seismic method.

18. The method of claim. 11, wherein measuring low-frequency acoustic signals and superimposing the passive data with the static 3D data is performed at regular intervals to create a dynamic model of time-dependant changes of a fluid.

19. The method of claim 18, further comprising measuring geophysical data and integrating the geophysical data with the passive data and the static 3D data in the model.

20. A system for detecting fluid changes in a subterranean reservoir, comprising:
one or more acoustic sensors for passively measuring low-frequency acoustic signal data representing a property of a fluid in a subterranean reservoir; and
a processing device comprising a computer readable medium including static 3D data stored thereon, the static 3D data representing the structure of the subterranean reservoir and having been collected with a reflection-seismic method,
wherein the processing device is configured to generate a model representing time-dependent changes of the fluid in the subterranean reservoir by superimposing the acoustic signal data with the static 3D data.

21. The system according to claim 20, wherein the acoustic sensors are permanently installed at sites near the subterranean reservoir and configured to make a plurality of measurements.

22. A method for monitoring an area for trespassers comprising:
passively measuring a spectrum of low-frequency acoustic signals with acoustic sensors,
storing the low-frequency acoustic signals on a computer readable medium as signal data; and
evaluating the signal data for indicators of a trespasser.

23. The method of claim 22, wherein the Vindicator includes anomalies in the amplitude of the acoustic signals in the spectrum.
